(19) United States
(12) Patent Application Publication
(10) Pub. No.: US 2014/0178221 A1
(43) Pub. Date: Jun. 26, 2014

(54) FLUID DYNAMIC PRESSURE BEARING ASSEMBLY, SPINDLE MOTOR INCLUDING THE SAME, ELECTRIC BLOWER INCLUDING THE SAME, AND VACUUM CLEANER INCLUDING THE SAME

(71) Applicant: SAMSUNG ELECTRO-MECHANICS CO., LTD., Suwon (KR)

(72) Inventor: Yong Wan CHO, Suwon (KR)

(73) Assignee: SAMSUNG ELECTRO-MECHANICS CO., LTD., Suwon (KR)

(21) Appl. No.: 13/784,558

(22) Filed: Mar. 4, 2013

(30) Foreign Application Priority Data
Dec. 20, 2012 (KR) 10-2012-0149146

(51) Int. Cl. F16C 32/06; H02K 7/08

(52) U.S. Cl. CPC F16C 32/0696; H02K 7/08
USPC 417/420; 384/107; 310/90

(57) ABSTRACT

There are provided a fluid dynamic pressure bearing assembly, a spindle motor including the same, an electronic blower including the same, and a vacuum cleaner including the same. The fluid dynamic pressure assembly includes: a shaft fixedly installed on a base member; and a sleeve having an axial hole fixed to an outer circumferential surface of the shaft and rotatably supported by fluid dynamic pressure, wherein when the sleeve is inclined, based on an axial direction while being rotated, the sleeve comes into line-contact or surface-contact with the shaft in the axial direction.

### CROSS-REFERENCE TO RELATED APPLICATIONS

This application claims the priority of Korean Patent Application No. 10-2012-0149146 filed on Dec. 20, 2012, in the Korean Intellectual Property Office, the disclosure of which is incorporated herein by reference.

### BACKGROUND OF THE INVENTION

1. Field of the Invention

The present invention relates to a fluid dynamic pressure bearing assembly, a spindle motor including the same, an electronic blower (i.e., a motor ventilator or a motor fan) including the same, and a vacuum cleaner (or an electric cleaner) including the same.

2. Description of the Related Art

In a high speed rotary motor employing a dynamic pressure bearing using a fluid such as air, liquid, or the like, bearing lifespan is critical. When a rotor is rotated at high speed, both end portions of a shaft system are repeatedly brought into contact with each other due to movement, so both end portions may first be abraded, relative to other portions of the shaft system.

Namely, the related art dynamic pressure bearing using a fluid includes a shaft and a sleeve disposed to be rotated relatively thereto. Here, a fluid such as air, a fluid, or the like, is interposed between the shaft and the sleeve, serving as a bearing. In this case, a bearing clearance is formed between the shaft and the sleeve, so the shaft and the sleeve are spaced apart from one another. Thus, when the shaft and the sleeve are relatively rotated, both end portions of the shaft system are brought into contact with one another iteratively due to inertial movement, and thus, both end portions may be abraded first, relative to other portions of the shaft system.

When the end portions of the shaft system are abraded due to frictional contact, motor performance may be degraded within a short time.

### SUMMARY OF THE INVENTION

An aspect of the present invention provides a dynamic pressure bearing assembly and a spindle motor in which end portions of a shaft system are not abraded first in spite of long term use.

An aspect of the present invention provides a spindle motor having a lifespan lengthened by considerably reducing abrasion of end portions of a shaft system by simply modifying shapes of components constituting the shaft system.

According to an aspect of the present invention, there is provided a fluid dynamic pressure assembly including: a shaft fixedly installed on a base member; and a sleeve having an axial hole fixed to an outer circumferential surface of the shaft and rotatably supported by fluid dynamic pressure, wherein when the sleeve is inclined, based on an axial direction while being rotated, the sleeve comes into line-contact or surface-contact with the shaft in the axial direction.

The shaft may include first and second tapered portions formed in upper and lower portions of a fluid dynamic pressure bearing unit in the axial direction and having diameters gradually reduced toward end portions of the shaft.

The first and second tapered portions may have the same slope angle based on the axial direction.

The sleeve may include third and fourth tapered portions formed in the upper and lower portions of a fluid dynamic pressure bearing unit in the axial direction, such that a diameter of the axial hole thereof is gradually increased toward end portions of the sleeve.

The third and fourth tapered portions may have the same slope angle based on the axial direction.

The fluid dynamic pressure assembly may further include a magnetic bearing including magnets provided in the shaft and the sleeve, respectively, in at least one of upper and lower portions of the fluid dynamic pressure bearing unit in the axial direction among portions of the shaft and the sleeve facing each other, such that magnets having the same polarity face each other.

An outer surface of the magnet provided in the shaft in the radial direction in the magnetic bearing may have the same slope angle as that of an adjacent slope angle among the first and second tapered portions and may be sloped in the same direction.

The fluid dynamic pressure assembly may further include a magnetic bearing including magnets provided in the shaft and the sleeve, respectively, in at least one of upper and lower portions of the fluid dynamic pressure bearing unit in the axial direction among portions of the shaft and the sleeve facing each other, such that magnets having the same polarity face each other.

An outer surface of the magnet provided in the sleeve in the radial direction in the magnetic bearing may have the same slope angle as that of an adjacent slope angle among the third and fourth tapered portions and may be sloped in the same direction.

According to another aspect of the present invention, there is provided a spindle motor including: the foregoing fluid dynamic pressure bearing assembly; a magnet coupled to an outer surface of the sleeve; and a stator core installed on the base member such that it faces the magnet, and allowing a coil to be wound therearound.

According to another aspect of the present invention, there is provided an electric blower including: the foregoing spindle motor; an impeller installed on the sleeve and drawing in air; a diffuser coupled to the base member such that it is disposed at an end portion of the impeller in a radial direction, and guiding a path of drawn in air; and a cover coupled to the base member to accommodate the spindle motor, the impeller, and the diffuser therein.

The cover may serve as a stopper preventing the impeller from moving upwardly in an axial direction.

A ball installation recess may be provided in an upper end of the shaft to allow a bearing ball to be disposed therein.

A top plate may be provided on an inner surface of the impeller facing the bearing ball provided in an upper end of the shaft.

According to another aspect of the present invention, there is provided a vacuum cleaner including: a dust collecting chamber communicating with an inlet to which a hose is connected; an electric blower chamber formed on a rear side of the dust collecting chamber; and an electric blower installed in the electric blower chamber.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cut perspective view of an electric blower according to an embodiment of the present invention;

FIG. 2 is a perspective view of a shaft used in a fluid dynamic pressure bearing assembly according to an embodiment of the present invention;

FIG. 3 is a cross-sectional perspective view of the fluid dynamic pressure bearing assembly according to an embodiment of the present invention;

FIGS. 4A and 4B are cross-sectional perspective views illustrating a configuration in which a sleeve is sloped based on an axial direction in the fluid dynamic pressure bearing assembly according to an embodiment of the present invention, respectively;

FIG. 5 is a perspective view of a sleeve used in a fluid dynamic pressure bearing assembly according to another embodiment of the present invention;

FIG. 6 is a cross-sectional perspective view of the fluid dynamic pressure bearing assembly according to another embodiment of the present invention;

FIGS. 7A and 7B are cross-sectional perspective views illustrating a configuration in which a sleeve is sloped based on an axial direction in the fluid dynamic pressure bearing assembly according to another embodiment of the present invention, respectively;

FIG. 8 is a perspective view illustrating the exterior of a vacuum cleaner according to an embodiment of the present invention; and

FIG. 9 is a vertical sectional view of the vacuum cleaner according to an embodiment of the present invention.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like components.

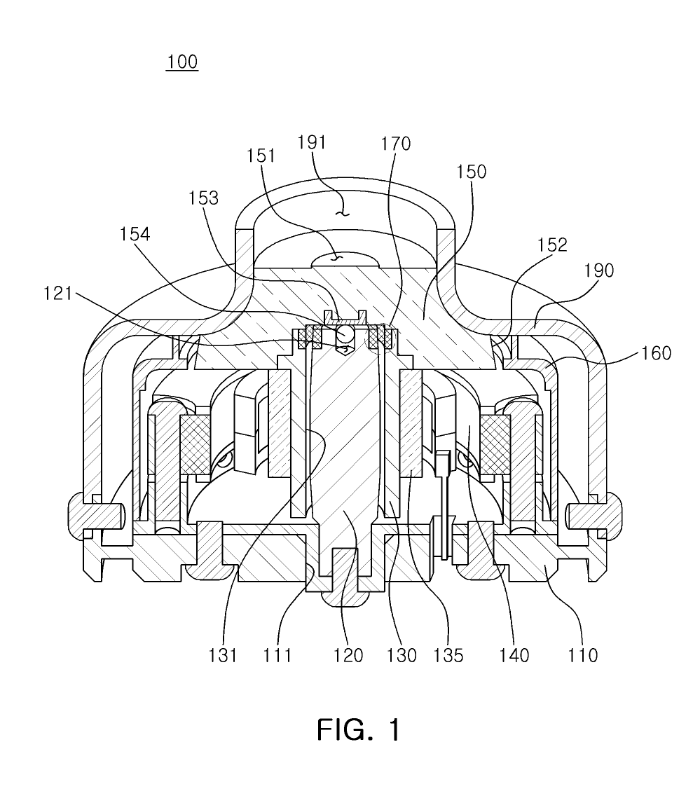

FIG. 1 is a cut perspective view of an electric blower according to an embodiment of the present invention.

Referring to FIG. 1, an electric blower 100 according to an embodiment of the present invention may include a spindle motor including a base member 110, a shaft 120, a sleeve 130, a magnet 135, and a stator core 140, an impeller 150, a diffuser 160, and a cover 190.

First, referring to definitions of directional terms, an axial direction may refer to a vertical direction, i.e., a direction from a lower end of the shaft 120 to an upper end thereof or a direction from the upper end of the shaft 120 to the lower end thereof when viewed in FIG. 1, a radial direction may refer to a horizontal direction, i.e., a direction from the shaft 120 to an outer edge of the diffuser 160 or a direction from the outer edge of the diffuser 160 to the shaft 120 and a circumferential direction may refer to a direction in which a rotation is made along a predetermined radius based on a rotational center, when viewed in FIG. 1. For example, the circumferential direction may refer to a direction in which a rotation is made along an outer edge of the diffuser 160.

In the electric blower 100 according to an embodiment of the present invention, a rotating member may be relatively rotated smoothly with respect to a fixed member by using fluid dynamic pressure bearing assemblies 200 and 300.

Here, the fluid dynamic pressure bearing assemblies 200 and 300 may include members generating fluid dynamic pressure in the medium of air as a lubricating fluid (or liquid), or the like, to rotate relatively, and may include the shaft 120 and the sleeve 130. In addition, the fluid dynamic pressure bearing assemblies 200 and 300 may selectively include a magnetic bearing unit 170.

The rotating member, a member relatively rotating with respect to the fixed member, may include the sleeve 130, the magnet 130, and the impeller 150.

The fixed member, a member fixed relative to the rotating member, may include the base member 110, the shaft 120, the stator core 140, the diffuser 160, and the cover 190.

The base member 110 is a member in which the foregoing fixed member is installed. The base member 110 may form a housing of the electric blower 100. Also, as the foregoing cover 190 is coupled to an upper portion of the base member 190 to from an internal space, components constituting the electric blower 100 may be disposed in the internal space.

The base member 110 may include an installation recess or an installation hole 111 to allow the shaft 120 to be fixed therein. Also, the stator core 140, the diffuser 160, and the cover 190 may be coupled to the base member 110. In FIG. 1, a configuration in which the stator core 140, the diffuser 160, and the cover 190 are fixed to the base member 110 in a screw fastening manner is illustrated, but these components may be coupled to the member 110 according to various member coupling methods.

The base member 110 according to the present embodiment may be fabricated by performing plastic working on a rolled steel sheet (or a rolled plate). In detail, the base member 110 may be fabricated through pressing, stamping, deep drawing, or the like. However, the fabrication of the base member 110 is not limited thereto and the base member 110 may be fabricated according to various non-illustrated methods, such as aluminum die casting, or the like. The shaft 120 may be fixed to the base member 110. It is illustrated that the shaft 120 is screw-fastened in the installation recess or installation hole 111 by the medium of an additional member. However, the present invention is not limited thereto and the shaft 120 may be fixed in the installation recess or installation hole 111 according to various inter-member coupling methods such as press fitting, bonding, welding, or the like, without using an additional member.

The shaft 120 may have a fixed portion 122, which is coupled to the installation recess or installation hole 111, on a lower portion thereof. In addition, the shaft 120 may include dynamic pressure generating grooves 126 formed on an outer circumferential surface thereof to facilitate a generation of a fluid dynamic pressure between the shaft 120 and the sleeve 130 fixed to the outer circumferential surface of the shaft 120. The dynamic pressure generating grooves 126 may have at least one pattern among a herringbone pattern, a spiral pattern, and a helical pattern.

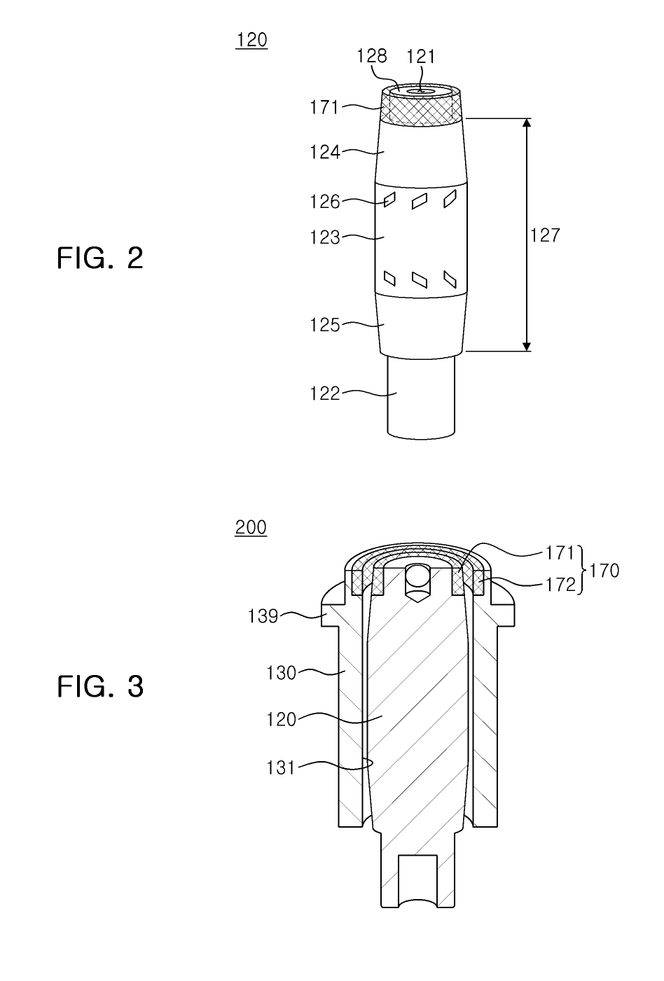

A specific configuration of the shaft 120 will be described in detail with reference to FIGS. 2 through 4B hereinafter.

The sleeve 130 may be fixed to the outer circumferential surface of the shaft 120. In detail, the shaft 120 may be inserted into an axial hole 131 formed in a penetrative manner in an axial direction in the sleeve 130. Of course, the shaft 120 and the sleeve 130 may be spaced apart from one another, with a bearing clearance C formed therebetween. The bearing clearance C may be filled with a lubricating fluid such as air, a liquid, or the like.

In addition, the dynamic pressure generating grooves 126 may not be limited to the formation thereof on the outer circumferential surface of the shaft 110. Namely, the dynamic pressure generating grooves 126 may also be formed on an inner circumferential surface of the sleeve 130, i.e., on an inner wall of the axial hole 131. Also, an impeller installation portion 139 may be provided in an upper portion of the sleeve 130 in the axial direction on an outer side in the radial direction. The impeller 150 may be installed on an upper portion of the sleeve 130 in the axial direction and rotated together with the sleeve 130.

Meanwhile, a magnetic bearing unit 170, including magnets 171 and 127, may be in at least one of upper and lower portions of the fluid dynamic pressure bearing units 127 and 137 in the axial direction among portions in which the shaft 120 and the sleeve 130 face one another, such that magnets having the same polarity face one another.

A magnet installation portion 128, in which the first magnet 171 is installed, may be provided in an upper portion of the fluid dynamic pressure bearing unit 127 in the axial direction of the shaft 120. Although not shown, the first magnet 171 may be installed on a lower portion of the fluid dynamic pressure bearing unit 127 in the axial direction of the shaft 120.

Also, a magnet installation portion 138, in which the second magnet 172 is installed, may be provided in an upper portion of the fluid dynamic pressure bearing unit 137 in the axial direction of the sleeve 130. Although not shown, the second magnet 172 may be installed on a lower portion of the fluid dynamic pressure bearing unit 137 in the axial direction of the sleeve 130. Namely, the second magnet 172 may be installed on a position corresponding to the first magnet 171.

The impeller 150 may be installed on an upper portion of the sleeve 130 in the axial direction and rotated together with the sleeve 130. The impeller 150 may include an inlet 151 provided at the rotation center, i.e., in an upper portion of the shaft 120 in the axial direction, to draw in ambient air. Thus, the impeller 150 may have a fan having a structure for drawing in ambient air through rotation. In addition, the impeller 150 may draw in air through the inlet 151 and push air out of an outlet 152 provided in an outer edge thereof in the radial direction.

Meanwhile, although the impeller 150 is installed on the sleeve 130, since the impeller 150 is positioned in an upper portion of the shaft 120, it may be in contact with an upper end of the shaft 120 in the axial direction. Thus, a ball installation recess 121 may be provided in the upper end of the shaft 120 and a bearing ball 154 may be provided in the ball installation recess 121. Namely, the shaft 120 and the impeller 150 may rotate relatively, while minimizing frictional force therebetween by means of the bearing ball 154. In addition, a top plate 153, which is abrasion-resistant, may be provided in a portion of the impeller 150 facing the upper end portion of the shaft 120 in the axial direction.

The diffuser 160 may be fixedly installed to the base member 110. The diffuser 160 may be connected to the outlet 152 of the impeller 150 to guide air drawn in through the impeller 150 to a predetermined path. Namely, the diffuser 160 may have a guide vane to guide drawn in air along a particular path.

Meanwhile, the magnet 135 may be provided on an outer surface of the sleeve 135 in the radial direction. In addition, the stator core 140 may be provided on an outer side of the magnet 135 in the radial direction, such that the stator core 140 faces the magnet 135. A coil is wound around the stator core 140 to form electromagnet interacting with the magnet 135 by power supplied thereto. Thus, the electromagnet may interact with the magnet 135 to provide rotation power of the sleeve 130.

Meanwhile, the stator core 140 may be fixedly installed on the base member 110.

The cover 190 may be coupled to the base member 110 to accommodate the spindle motor, the impeller 150, and the diffuser 160 therein. Namely, the cover 190 may be coupled to the base member 110 to form an internal space accommodating the spindle motor, the impeller 150, the diffuser 160, and the like, therein. The cover 190 may have an inlet 191 provided in a position corresponding to the inlet 151 of the impeller 150 to allow the internal space to communicate with the exterior.

Meanwhile, the cover 190 may serve as a stopper preventing the impeller 150 from moving upwardly in the axial direction.

Meanwhile, the electric blower 100 according to an embodiment of the present invention includes the shaft and the sleeve disposed to rotate relatively, as a dynamic pressure bearing using a fluid. Here, a fluid such as air, a liquid, or the like, is interposed between the shaft and the sleeve to serve as a bearing. In this case, since a bearing clearance is required to be formed between the shaft and the sleeve, so the shaft and the sleeve are spaced apart from one another by a predetermined interval. Thus, when the shaft and the sleeve rotate relatively, both end portions of the shaft system come into contact iteratively due to moment of inertia, i.e., rotational moment (or torque), and thus, both end portions of the shaft system may be abraded first relative to other portions thereof. When the end portions of the shaft system are abraded due to frictional contact, performance of the motor may be degraded within a short time. Thus, in an embodiment of the present invention, such a problem is solved by using fluid dynamic pressure bearing assemblies 200 and 300 illustrated in FIGS. 2 through 7B.

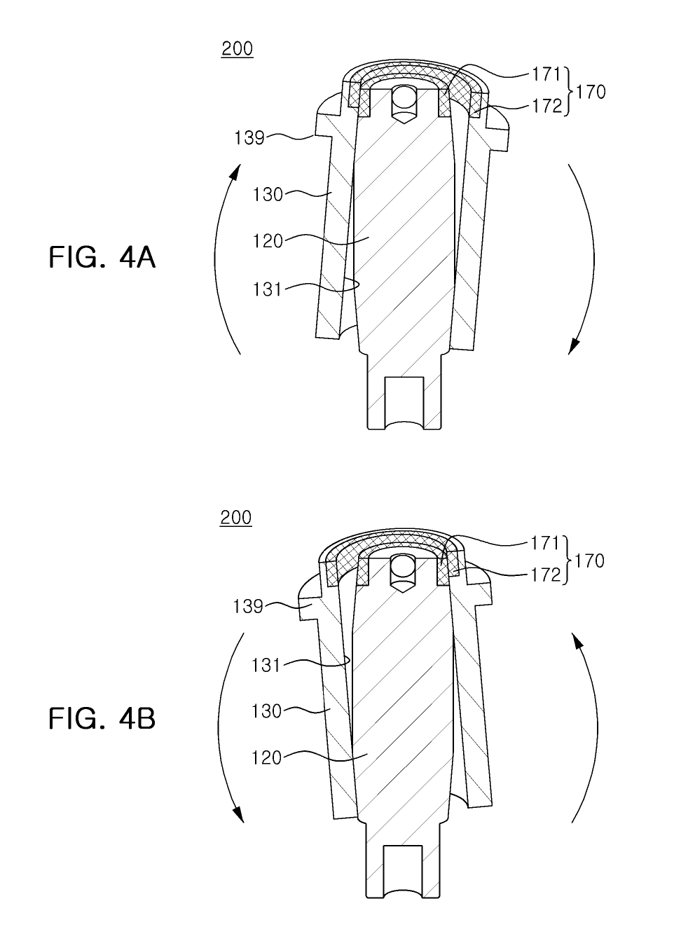

FIG. 2 is a perspective view of a shaft used in a fluid dynamic pressure bearing assembly according to an embodiment of the present invention. FIG. 3 is a cross-sectional perspective view of the fluid dynamic pressure bearing assembly according to an embodiment of the present invention. FIGS. 4A and 4B are cross-sectional perspective views illustrating a configuration in which a sleeve is sloped based on an axial direction in the fluid dynamic pressure bearing assembly according to an embodiment of the present invention, respectively.

Referring to FIG. 2, a configuration of the shaft 120 is illustrated. Namely, the shaft 120 may be provided to be in line-contact or surface-contact with the sleeve 130 in the axial direction when the sleeve 130 is inclined, based on the axial direction during a rotation operation.

Namely, the shaft 120 may have first and second tapered portions 124 and 125 formed in upper and lower portions of the fluid dynamic pressure bearing unit 127 in the axial direction, such that diameters thereof are reduced toward the end portions of the shaft 120. The first and second tapered portions 124 and 125 may have the same slope angle based on the axial direction. In this case, however, a slope direction of the first and second tapered portions 124 and 125 may be the opposite. Namely, the shaft 120 may have the first and second tapered portions 124 and 125 formed on the upper and lower portions of the fluid dynamic pressure bearing unit 127 in the axial direction and sloped to have diameters reduced toward the end portions of the shaft 120.

In the case that the first and second tapered portions 124 and 125 are formed in the upper and lower portions of the shaft 120 in the axial direction based on the fluid dynamic pressure bearing unit 127, although the sleeve 130 is inclined at a predetermined angle based on the axial direction, the sleeve 130 comes in line-contact or surface-contact with the shaft 120 in the axial direction. Thus, since the contact portion therebetween is increased, abrasion due to the contact of the shaft 120 or the sleeve 130 can be considerably reduced, improving performance of the motor and lengthening a lifespan of the motor.

Meanwhile, a non-sloped portion 123 may be formed between the first tapered portion 124 and the second tapered portion 125 in the axial direction. The non-sloped portion 123 has an outer surface parallel to the axial direction. The dynamic pressure generating grooves 126 may be formed on an outer circumferential surface of the non-sloped portion 123 to facilitate a generation of fluid dynamic pressure between shaft 120 and the sleeve 130 in the circumferential direction. The dynamic pressure generating grooves 126 may have any pattern among a herringbone pattern, a spiral pattern, and a helical pattern.

Meanwhile, the fluid dynamic pressure bearing assembly 200 according to the present embodiment may include the magnetic bearing 170 including first and second magnets 171 and 172 provided in the shaft 120 and the sleeve 130, respectively. In this case, the first and second magnets 171 and 172 may be provided in at least one of upper and lower portions of the fluid dynamic pressure bearing unit 127 in the axial direction among portions of the shaft 120 and the sleeve 130 facing each other, such that magnets having the same polarity face each other. Namely, the first and second magnets 171 and 172 are disposed such that the same polarities thereof face each other, whereby the magnetic bearing 170 may serve as an additional bearing. In the drawings, the magnetic bearing 170 provided in the upper portion of the shaft 120 is illustrated, but the present invention is not limited thereto and the magnetic bearing 170 may also be provided in a lower portion of the shaft 120 in the axial direction in the same manner.

Here, in the magnetic bearing 170, an outer surface of the first magnet 171 provided in the shaft 120 in the radial direction may have the same slope angle as that of an adjacent slope angle of the first tapered portion 124 and the second tapered portion 125 and may be sloped in the same direction. Namely, since the first magnet 171 also faces the sleeve 130, when the sleeve 130 is inclined, based on the axial direction, the first magnet 171 may come into contact with the sleeve 130. Thus, in the present embodiment, the first magnet 171 may be formed to be sloped like the first tapered portion 124 and the second tapered portion 125 of the shaft 120 so as to be in line-contact or surface-contact with the facing second magnet 172 in the axial direction.

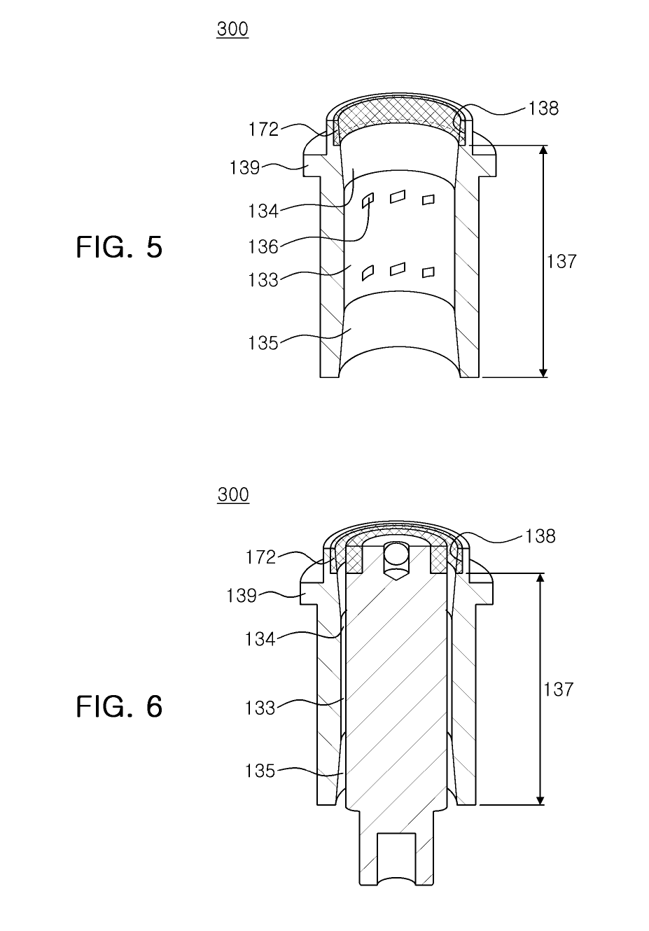

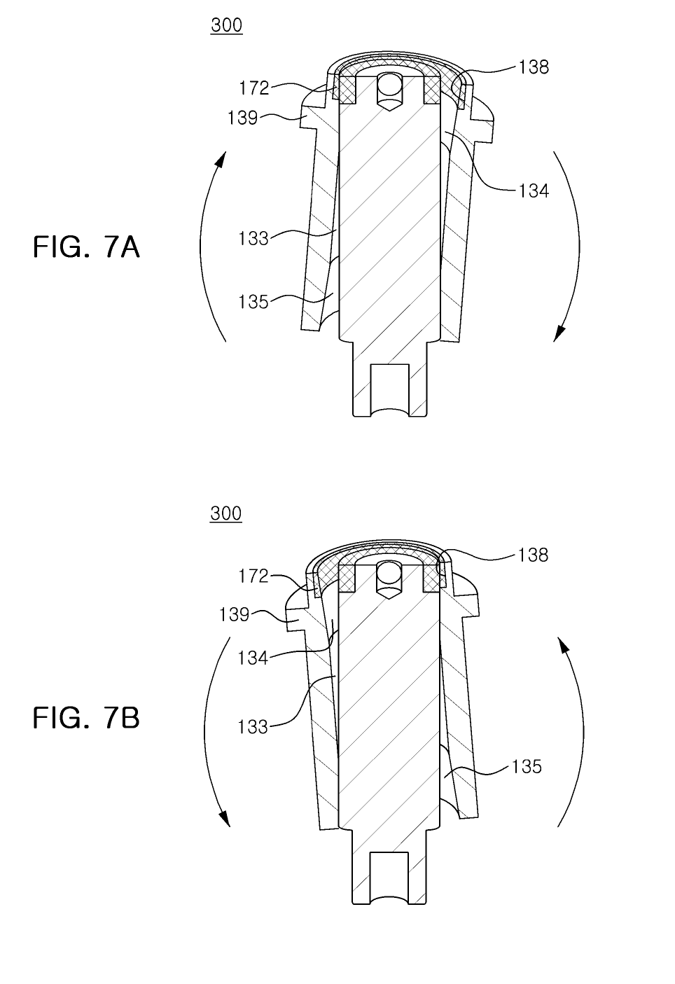

FIG. 5 is a perspective view of a sleeve used in a fluid dynamic pressure bearing assembly according to another embodiment of the present invention. FIG. 6 is a cross-sectional perspective view of the fluid dynamic pressure bearing assembly according to another embodiment of the present invention. FIGS. 7A and 7B are cross-sectional perspective views illustrating a configuration in which a sleeve is sloped based on an axial direction in the fluid dynamic pressure bearing assembly according to another embodiment of the present invention, respectively.

Referring to FIGS. 3 through 4B, in the fluid dynamic pressure bearing assembly 200 according to an embodiment of the present invention described above with reference to FIGS. 3 through 4B, the outer surface of the shaft 110 in the radial direction is provided to be sloped to improve abrasion of the end portions of the sleeve or the shaft.

Meanwhile, in the fluid dynamic pressure bearing assembly 300 according to an embodiment of the present invention described hereinafter with reference to FIGS. 5 through 7B, abrasion of the end portions of the sleeve or the shaft can be improved through a configuration in which an inner surface of the sleeve 130, i.e., an inner wall surface of the axial hole 131, is formed to be sloped

Referring to FIG. 5, a configuration of the sleeve 130 according to another embodiment of the present invention is illustrated. Namely, the sleeve 130 may be provided such that the shaft 120 and the sleeve 130 come into line-contact or surface-contact in the axial direction when the sleeve 130 is inclined, based on the axial direction during a rotational operation.

Namely, the sleeve 130 may have third and fourth tapered portions 134 and 135 formed on upper and lower portions of the fluid dynamic bearing unit 137 and sloped such that a diameter of the axial hole 131 is increased toward the end portions of the sleeve 130. The third and fourth tapered portions 134 and 135 may have the same slope angle based on the axial direction. However, the slope directions of the third and fourth taped portions 134 and 135 may be the opposite. Namely, the sleeve 130 may have the third and fourth tapered portions 134 and 135 on the upper and lower portions of the fluid dynamic pressure bearing unit 137 in the axial direction, such that the diameter of the axial hole 131 is increased toward the end portions of the sleeve 130.

In the case that the third and fourth tapered portions 134 and 135 are formed in the upper and lower portions of the sleeve 130 in the axial direction based on the fluid dynamic pressure bearing unit 137, although the sleeve 130 is inclined at a predetermined angle based on the axial direction, the shaft 120 and the sleeve 130 come into line-contact or surface-contact in the axial direction. Thus, since the contact portion therebetween is increased, abrasion due to the contact of the shaft 120 or the sleeve 130 is considerably reduced, improving performance of the motor and lengthening a lifespan of the motor.

Meanwhile, a non-sloped portion 133 may be formed between the third tapered portion 134 and the fourth tapered portion 135 in the axial direction. The non-sloped portion 133 has an inner surface parallel to the axial direction. Dynamic pressure generating grooves 136 may be formed on an inner circumferential surface of the non-sloped portion 133 to facilitate a generation of fluid dynamic pressure between shaft 120 and the sleeve 130 in the circumferential direction. The dynamic pressure generating grooves 136 may have any pattern among a herringbone pattern, a spiral pattern, and a helical pattern.

Meanwhile, the fluid dynamic pressure bearing assembly 300 according to the present embodiment may include the magnetic bearing 170 including the first and second magnets 171 and 172 provided in the shaft 120 and the sleeve 130, respectively. In this case, the first and second magnets 171 and 172 may be provided in at least one of upper and lower portions of the fluid dynamic pressure bearing unit 137 in the axial direction among portions of the shaft 120 and the sleeve 130 facing each other, such that magnets having the same polarity face each other. Namely, the first and second magnets 171 and 172 are disposed such that the same polarities thereof face each other, whereby the magnetic bearing 170 may serve as an additional bearing. In the drawings, the magnetic bearing 170 provided in the upper portion of the shaft 120 is illustrated, but the present invention is not limited thereto and the magnetic bearing 170 may also be provided in a lower portion of the shaft 120 in the axial direction in the same manner.

Here, in the magnetic bearing 170, an inner surface of the second magnet 172 provided in the sleeve 130 in the radial direction may have the same slope angle as that of an adjacent slope angle of the third tapered portion 134 and the fourth tapered portion 135 and may be sloped in the same direction. Namely, since the second magnet 172 also faces the shaft 120, when the sleeve 130 is inclined, based on the axial direction, the second magnet 172 may come into contact with the sleeve 130. Thus, in the present embodiment, the second magnet 172 may be formed to be sloped like the third tapered portion 134 and the fourth tapered portion 135 of the sleeve 130 so as to be in line-contact or surface-contact with the facing first magnet 171 in the axial direction.

Meanwhile, a fluid dynamic pressure bearing assembly according to another embodiment of the present invention may include all the first tapered portion 124 and the second tapered portion 125 provided on the shaft 120 and the third tapered portion 134 and the fourth tapered portion 135 provided on the sleeve 130.

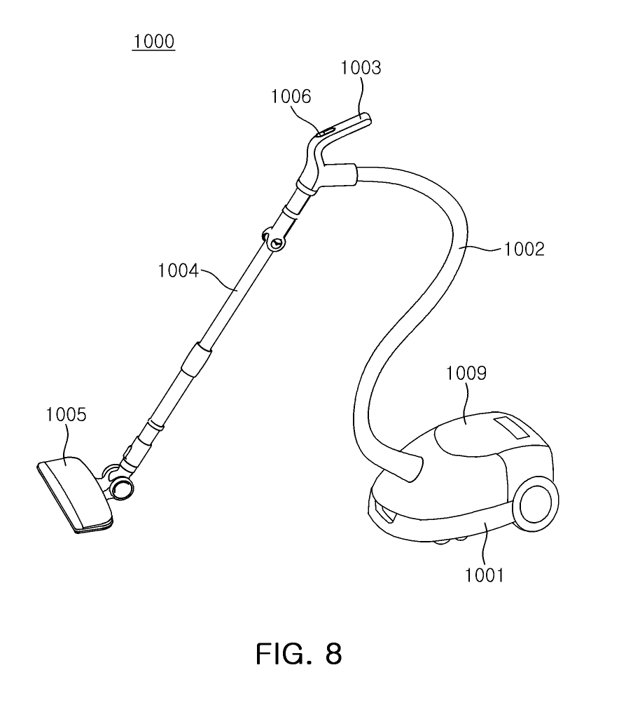

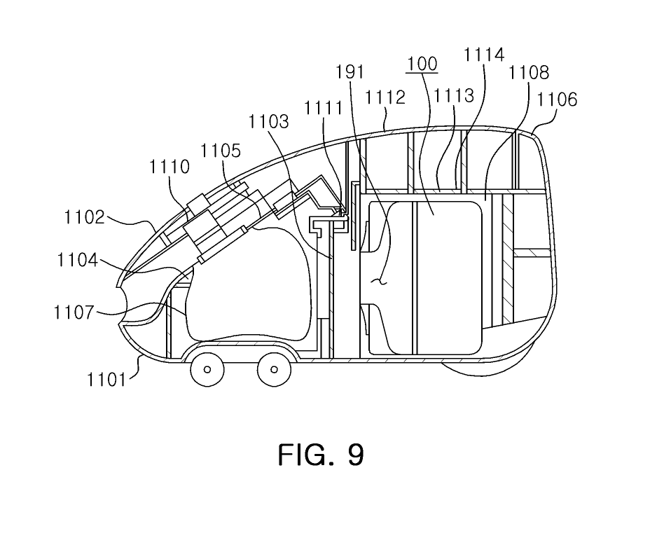

FIG. 8 is a perspective view illustrating the exterior of a vacuum cleaner according to an embodiment of the present invention. FIG. 9 is a vertical sectional view of the vacuum cleaner according to an embodiment of the present invention.

Referring to FIG. 8, a vacuum cleaner 1000 according to an embodiment of the present invention may include a cleaner body 1001, a hose 1002 extending from the cleaner body 1001 and having one end communicating with an inlet port of the cleaner body 1001, a handle unit 1003 connected to the other end of the hose 1002, an extending pipe 1004 extending from the handle unit 1003, and an intake member 1005 provided in an end portion of the extending pipe 1004.

A button 1009 may be provided on the cleaner body 1001 for releasing cover of the cleaner body 1001.

The handle 1003 may include a switch manipulation unit 1006 to manipulate the vacuum cleaner 1000.

Referring to FIG. 9, the cleaner body 1001 may include a lower case 1101 formed on a front side thereof and covering a lower portion thereof, a cover member 1102 covering an upper portion of a front surface thereof, an inlet 1103 installed on the cover member 1102, a dust collecting chamber 1104 receiving a dust collecting pocket 1107, and an air-tightness maintaining cover 1105 installed on the cover member 1102. Here, the airtight maintaining cover 1104 is provided as an additional member aside from the cover member 1102 in order to maintain air-tightness of the interior of the dust collecting chamber 1104. An electric blower chamber 1108 provided on a rear side is formed by the lower case 1101 and an upper case 1106. Also, the dust collecting chamber 1104 includes the dust collecting pocket 1107. Also, the electric blower chamber 1108 includes an electric blower 100 for collecting dust. A filter 1110 is installed on an intake port 191 side of the electric blower 100 and communicates with the dust collecting chamber 1104. A packing 1111 is disposed in an upper portion of a wall surface of the lower case 1101 forming a lower portion of the dust collecting camber 1104. The packing 1111 and the air-tightness maintaining cover 1105 are in pressure-contact to maintain air-tightness of the dust collecting chamber 1104. A board receiving portion 1113 covered by an upper case cover 1112 is formed in an upper portion of the upper case 1106, and a control board 1114 is received in the board receiving portion 1113.

As set forth above, according to embodiments of the invention, a dynamic pressure bearing assembly and a spindle motor in which the end portions of the shaft system are not abraded first in spite of a long term use can be provided.

Also, since abrasion of the end portions of the shaft system can be considerably reduced by simply modifying the shape of components constituting the shaft system, a lifespan of the spindle motor can be lengthened simply.

While the present invention has been shown and described in connection with the embodiments, it will be apparent to those skilled in the art that modifications and variations can be made without departing from the spirit and scope of the invention as defined by the appended claims.

What is claimed is:

1. A fluid dynamic pressure assembly comprising:
a shaft fixedly installed on a base member; and
a sleeve having an axial hole fixed to an outer circumferential surface of the shaft and rotatably supported by fluid dynamic pressure,
wherein when the sleeve is inclined, based on an axial direction while being rotated, the sleeve comes into line-contact or surface-contact with the shaft in the axial direction.

2. The fluid dynamic pressure assembly of claim 1, wherein the shaft includes first and second tapered portions formed in upper and lower portions of a fluid dynamic pressure bearing unit in the axial direction and having diameters gradually reduced toward end portions of the shaft.

3. The fluid dynamic pressure assembly of claim 2, wherein the first and second tapered portions have the same slope angle based on the axial direction.

4. The fluid dynamic pressure assembly of claim 1, wherein the sleeve includes third and fourth tapered portions formed in the upper and lower portions of a fluid dynamic pressure bearing unit in the axial direction, such that a diameter of the axial hole thereof is gradually increased toward end portions of the sleeve.

5. The fluid dynamic pressure assembly of claim 4, wherein the third and fourth tapered portions have the same slope angle based on the axial direction.

6. The fluid dynamic pressure assembly of claim 2, further comprising: a magnetic bearing including magnets provided in the shaft and the sleeve, respectively, in at least one of upper and lower portions of the fluid dynamic pressure bearing unit in the axial direction among portions of the shaft and the sleeve facing each other, such that magnets having the same polarity face each other.

7. The fluid dynamic pressure assembly of claim 6, wherein an outer surface of the magnet provided in the shaft in the radial direction in the magnetic bearing has the same slope angle as that of an adjacent slope angle among the first and second tapered portions, and is sloped in the same direction.

8. The fluid dynamic pressure assembly of claim 4, further comprising: a magnetic bearing including magnets provided in the shaft and the sleeve, respectively, in at least one of upper and lower portions of the fluid dynamic pressure bearing unit in the axial direction among portions of the shaft and the sleeve facing each other, such that magnets having the same polarity face each other.

9. The fluid dynamic pressure assembly of claim 8, wherein an outer surface of the magnet provided in the sleeve in the radial direction in the magnetic bearing has the same slope angle as that of an adjacent slope angle among the third and fourth tapered portions, and is sloped in the same direction.

10. A spindle motor comprising:
the fluid dynamic pressure bearing assembly of claim 1;
a magnet coupled to an outer surface of the sleeve; and
a stator core installed on the base member such that it faces the magnet, and allowing a coil to be wound therearound.

11. An electric blower comprising:
the spindle motor of claim 10;
an impeller installed on the sleeve and drawing in air;
a diffuser coupled to the base member such that it is disposed at an end portion of the impeller in a radial direction, and guiding a path of drawn in air; and
a cover coupled to the base member to accommodate the spindle motor, the impeller, and the diffuser therein.

12. The electric blower of claim 11, wherein the cover serves as a stopper preventing the impeller from moving upwardly in an axial direction.

13. The electric blower of claim 11, wherein a ball installation recess is provided in an upper end of the shaft to allow a bearing ball to be disposed therein.

14. The electric blower of claim 13, wherein a top plate is provided on an inner surface of the impeller facing the bearing ball provided in an upper end of the shaft.

15. A vacuum cleaner comprising:
a dust collecting chamber communicating with an inlet to which a hose is connected;
an electric blower chamber formed on a rear side of the dust collecting chamber; and
an electric blower of any one of claims 11 to 14 installed in the electric blower chamber.
